(19) United States
(12) Patent Application Publication
(10) Pub. No.: US 2011/0167386 A1
(43) Pub. Date: Jul. 7, 2011

(54) Method and Device for Producing a Selection from an Items List

(75) Inventor: Joost Jelmer De Wit, Voorburg (NL)

(73) Assignee: Nederlandse Organisatie voor toegepastnatuurwetenschappelijk onderzoek TNO, Delft (NL)

(21) Appl. No.: 12/993,462

(22) PCT Filed: May 19, 2009
(86) PCT No.: PCT/NL2009/050267

§ 371 Date: Mar. 1, 2011

(30) Foreign Application Priority Data
May 19, 2008 (EP) 08156461.9

(51) Int. Cl. G06F 3/048

(52) U.S. Cl. 715/825; 715/810

(57) ABSTRACT

A device (1) for producing a selection from an items list (IL), the device comprising: a storage unit (21) for storing the items list (IL), an input/output unit (22) for interacting with a user (25), and a selection unit (20) for selecting items from the items list and supplying the selected items to the input/output unit (22), wherein the storage unit (21) is coupled with the input/output unit (22) for receiving first feedback (FB1) from the user and adjusting the items list in response to the first feedback, said first feedback relating to individual properties of the items, and wherein the selection unit (20) is also coupled with the input/output unit (22) for receiving second feedback (FB2) from the user and adjusting the selection unit (20) in response to the second feedback, said second feedback relating to collective properties of the selected items.

The present invention relates to a method and device for optimising recommendations to a user. More in particular, the present invention relates to a method and device for producing a selection from an items list using user feedback.

It is known to present recommendations to a user, based upon assumed or detected user preferences. Typically, the recommendations are checked for accuracy only: how accurately do the recommendations reflect the user's preferences.

The paper “Improving Recommendation Lists Through Topic Diversification” by Ziegler et al., WWW 2005 Conference, Chiba, Japan, May 2005, suggests to use diversity as an alternative to accuracy when making recommendation lists. Ziegler's paper focuses on the trade-off between only two criteria: accuracy versus satisfaction. However, this one-dimensional trade-off has a limited scope and the effectiveness that can be achieved by Ziegler's method is therefore also limited.

It is an object of the present invention to overcome these and other problems of the Prior Art and to provide a device and method for producing an optimised selection from an items list, which device and method are more effective, and which can therefore more readily be used for controlling consumer devices.

Accordingly, the present invention provides a device for producing a selection from an items list, the device comprising:
a storage unit for storing the items list,
an input/output unit for interacting with a user, and
a selection unit for selecting items from the items list and supplying the selected items to the input/output unit,
   wherein the storage unit is coupled with the input/output unit for receiving first feedback from the user and adjusting the items list in response to the first feedback, said first feedback relating to individual properties of the selected items, and wherein the selection unit is also coupled with the input/output unit for receiving second feedback from the user and adjusting the selection unit in response to the second feedback, said second feedback relating to collective properties of the selected items.

By using collective properties pertaining to the selection as a whole, a greater effectiveness of the selection process is obtained, as the selection will be more consistent with the user's preferences.

In preferred embodiments, at least two collective properties are used, thus achieving an even higher user satisfaction.

In summary, the present invention seeks to optimise the item selection process and thus optimise user satisfaction, in particular by “learning”, that is, by adjusting the selection (that is, the set of recommendations) using the feedback from the user(s). While the collective satisfaction of a group of users may be optimised, it is preferred that the satisfaction of individual users is optimized. User satisfaction is optimised by determining which properties (of items) are important to the user.

The feedback may comprise implicit feedback, that is feedback which is determined by the user's responses to the set or to certain recommendations. For example, if the user skips a recommended item, it can be concluded that the recommendation was not optimal. Additionally, or alternatively, the feedback may comprise explicit feedback: the user may state his approval or disapproval of a certain recommendation or set of recommendations. Hybrid feedback comprises both explicit and implicit feedback.

Explicit feedback may be carried out by the user scoring the sets of recommendations: the user provides a score (for example, between 1—very unsatisfactory-to 5—highly satisfactory) which expresses her satisfaction with the selection (set or list of recommendations). The scores indicate which properties are appreciated by the user and which are less or not appreciated.

The selection (set of recommendations) may be constituted by a playlist and consist of songs or video items which can be rendered by a suitable audio and/or video device. Advantageously, the optimising device of the present invention may be incorporated in a consumer device, such as an MP3 player, a CD player, a DVD player or a hard disc recorder.

In an advantageous embodiment, the recommendations are made to multiple users and the feedback may be received from multiple users.

The collective properties may include at least one of: accuracy, novelty, coverage, serendipity, diversity, and overlap.

The recommendations may concern audio and/or video clips, films, books, routes, CDs, DVDs, TV programs, musicals and/or plays.

The present invention further provides an entertainment system or consumer device, comprising a device as defined above. The entertainment system or consumer device may further comprise a server arranged for uploading recommended content.

The present invention also provides a method for producing a selection from an items list, the method comprising the steps of:
storing the items list,
interacting with a user, and
selecting items from the items list and supplying the selected items to the input/output unit,
   further comprising the steps of:
receiving first feedback from the user and adjusting the items list in response to the first feedback, said first feedback relating to individual properties of the selected items, and
receiving second feedback from the user and adjusting the selection unit in response to the second feedback, said second feedback relating to collective properties of the selected items.
   The feedback may comprise implicit feedback and/or explicit feedback. Hybrid feedback includes both implicit and explicit feedback.

The present invention additionally provides a computer program product for carrying out the method as defined above. A computer program product may comprise a set of computer executable instructions stored on a data carrier, such as a CD or a DVD. The set of computer executable instructions, which allow a programmable computer to carry out the method as defined above, may also be available for downloading from a remote server, for example via the Internet.

The present invention will further be explained below with reference to exemplary embodiments illustrated in the accompanying drawings, in which:

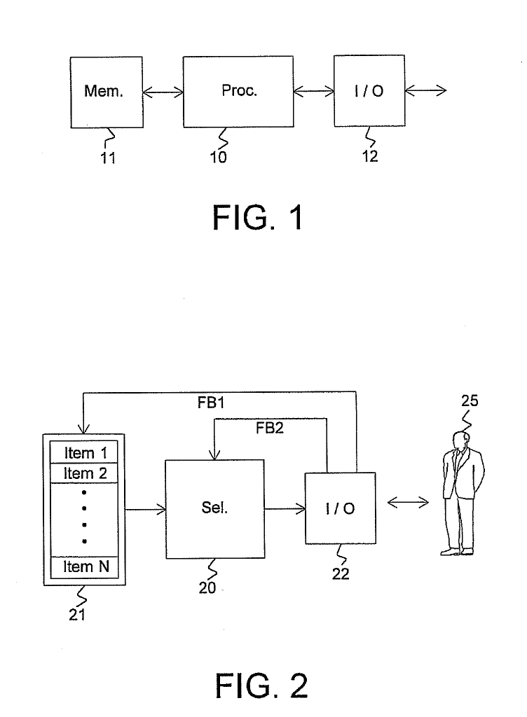

FIG. 1 schematically shows a first embodiment of a device for optimising a set of recommendations according to the present invention.

FIG. 2 schematically shows a second embodiment of a device according to the present invention.

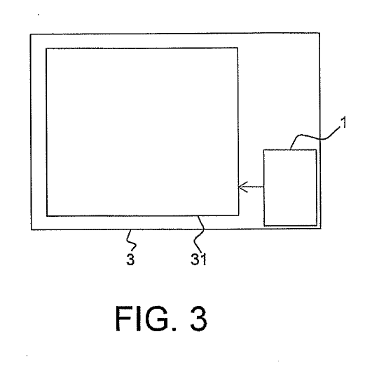

FIG. 3 schematically shows an exemplary embodiment of a consumer device according to the present invention.

The merely exemplary device 1 schematically illustrated in FIG. 1 comprises a processing unit 10, a memory unit 11 and an input/output (I/O) unit 12, which are mutually connected. The processing unit 10, which may comprise a microprocessor and associated circuitry, is capable of carrying out method steps defined by a software program stored in the memory unit 11. In addition, the processing unit 10 is capable of retrieving data from, and storing data in the memory unit 11, and of exchanging data with the input/output unit 12. The device 1 may be incorporated in a television apparatus, a set-top box, a personal video player, an MP3 or MP4 player, or another consumer device. The device 1 may serve to control the device it is incorporated in, such as a (personal) video player, by recording recommended (that is, selected) television programs, the selection (list of recommendations) having been compiled in accordance with the present invention.

The method of the present invention will be explained in more detail below with reference to FIG. 2, which schematically shows the method of the present invention by way of a selection unit or recommender 20, an items list IL stored in a storage unit 21 (comprising a suitable memory), and an input/output (I/O) unit 22 for interacting with a user 25. Although the method of the present invention may be applied to a plurality of users, only a single user is shown for the sake of clarity. The input/output (I/O) unit 22 outputs items to the user 25 and receives feedback from the user.

The items list IL contains items 1 . . . N which may represent songs, television programs, radio programs, food items, or other items. The number N may range from e.g. five to several millions, but will typically be equal to a few thousand. These items may be considered predictions of the user's preferences. The items list IL may be compiled by using an available supply of items, with or without a selection (pre-screening) of the items. A first feedback loop provides first user feedback FB1 on the individual items of the items list. This feedback may be active (the user produces a rating of the item), passive (the user selects or skips the item), or hybrid (both active and passive). This first user feedback FB1 is preferably used to “prune” the items list by deleting items.

The items of the items list IL are fed to the recommender 20, which serves to make a selection from the items list and to recommend this selection to the user via the I/O unit 22. The selection may include a drastically reduced number of items, for example only ten items, although (much) larger number of items may also be recommended. It will be understood that the actual number of recommended items will depend on the particular application and that the number of recommended television programs for one evening will be limited to about half a dozen, while the number of recommended songs for storing on a MP3 player may amount to hundreds or even a few thousand.

In accordance with the present invention, the method comprises a second feedback loop for providing second user feedback FB2 on the selection (that is, the set of recommended items). This second user feedback FB2 is fed to the recommender 20 and processed to adjust the selection criteria. In contrast to the first user feedback FB1, which is item-oriented feedback, the second user feedback FB2 is selection-oriented (collective or global) feedback. That is, the second user feedback concerns the recommended set of items as a whole, rather than as individual items. Properties of the recommended set as a whole are, for example, accuracy, novelty, coverage, serendipity, diversity and overlap. By using properties of the selected set, a much greater user satisfaction, a more efficient and effective selection process, and a better control of any controlled devices is achieved.

The selection unit or recommender 20 may use various methods for producing sets of recommendations, and for determining which properties of sets of recommendations are important to the user(s).

In a first embodiment of the present invention, the weight of a certain property is determined on the basis of the correlation between the user satisfaction of a set of items (selection) and the value of several metrics which measure the properties of a set. Such metrics are, for example, accuracy, diversity, novelty, programme, and/or overlap. An example is provided in the table below.

| | j = 0 | j = 1 | j = 2 | . . . | j = n |
|---|---|---|---|---|---|
| m^{x} | 0.563 | 0.791 | 0.192 | | 0.266 |
| u | 0.234 | 0.248 | 0.867 | | 0.794 |

In the first row of this table, denoted with m^{x}, measured values of the metric x are shown for a particular list (that is, set) j. In the second row, the (user satisfaction) values are listed which a user provided as feedback to the respective list j. The score sₓ of the metric x can then be determined according to the following formula (Pearson's correlation):

$${s}_{x} = \frac{{\sum }_{0 \leq j < n} ( {m}_{j}^{x} - \overline{{m}^{x}} ) ( {u}_{j} - \overline{u} )}{\sqrt{{\sum }_{0 \leq j < n} ( {m}_{j}^{x} - \overline{{m}^{x}} ) {\sum }_{0 \leq j < n} ( {u}_{j} - \overline{u} )}}$$

The score sₓ has a value in the range [−1, 1] and indicates to which extent a list of recommendations has to have property x to produce a higher user satisfaction.

In a second embodiment, clustering is used. In this embodiment, use is made of correlations between user satisfaction and the values of a metric, that is, the scores in the table below.

| | | User | | | | |
|---|---|---|---|---|---|---|
| | | 1 | 2 | 3 | . . . | N |
| Metric | 1 | score(1,1) | score(1,2) | | | |
| | 2 | score(2,1) | . . . | | | |
| | 3 | | | . . . | | |
| | . . . | | | | . . . | |
| | M | | | | | . . . |

These correlations can be calculated as described above. The clustering algorithm partitions the users into K predefined clusters on the basis of correlations corresponding with the M metrics. Specific weights with respect of the metrics can be associated with each cluster. When it is known to which cluster a certain user belongs, the associated weights are used to compile the list of recommendations.

In a third embodiment, the properties of the sets are weighted and the respective weights are determined. These weights can be used to determine to which extent a set should have a certain property, the weights indicating the importance of the property of the set to a particular user. A weight can be determined iteratively using the following formula:

$${W}_{u}^{′} ( {M}_{i} ) = {W}_{u} ( {M}_{i} ) + α \cdot \frac{r \cdot {V}_{j} ( {M}_{i} )}{\vert M \vert} .$$

In this formula, Wᵤ′(Mᵢ) is the new weight for a user u with respect to metric Mᵢ. The impact of cycling through the feedback loop is specified by the constant α. The value of r is the user's satisfaction with respect to the set of recommendations. Vⱼ(Mᵢ) is the value of the metric Mᵢ which the set of recommendations had. The number of metrics for which a weight is determined is |M|. The extent to which a certain metric Mᵢ is to be enhanced or diminished to improve the set of recommendations for the user u is determined by the weight Wᵤ(Mᵢ).

In a fourth embodiment of the present invention, discriminant analysis is used to distinguish the properties which contribute most to the satisfaction of a user. Reference is made to G. J. McLachlan's Discriminant Analysis and Statistical Pattern Recognition, Wiley Interscience (2004).

The recommender 20 of FIG. 2 may be implemented in software and/or in hardware. The items list IL may be stored in a suitable storage unit, while the recommendations may be presented, and the user feedback may be received, via an input/output (I/O) unit 22. Accordingly, the recommender 20 of FIG. 2 may be constituted by the processing unit 10 of FIG. 1, while the items list, together with suitable software, may be stored in the memory unit 11 of FIG. 1. The feedback loops may be constituted by suitable software processed by the processing unit 10, and/or by physical feedback lines (that is, suitable wiring in the device). Accordingly, the device illustrated in FIG. 2 may alternatively be implemented in software and thus represent the method of the present invention.

In accordance with the present invention, the user effectively determines which properties of the set of recommendations as a whole are important to her. The user feedback is fed to the recommender 20 which adjusts, if necessary, the properties appreciated by the user and compiles the next set of recommendations using the adjusted set of properties. Accordingly, a set of recommendations is produced using a set of collective properties which is based upon user feedback.

The present invention yields higher user satisfaction and is therefore more efficient than Prior Art methods. Accordingly, processing time is saved when similar satisfaction levels are to be achieved, or higher user satisfaction is achieved using the same amount of processing time.

The method of the present invention can be carried out by a dedicated device, as illustrated in FIG. 1 or 2, or by a suitably programmed general purpose computer. The dedicated device may be incorporated in a consumer device, such as a television set, a DVD player, a radio set, a set-top box, or an MP3 player.

In personal video recorder (PVR), the present invention may be utilised to produce a set of television programs which are to be recorded. The recording may be carried out automatically so as to present the user with a pre-recorded set of programs. Thus, the selection may also be supplied to the tuner or programming unit of the PVR so as to control the programming.

In a television or radio apparatus the present invention can be used to automatically select stations and/or programs. Accordingly, the present invention also provides an automatic television tuner and an automatic radio tuner. A consumer device according to the present invention is schematically illustrated in FIG. 3. The consumer device 3, which may be a television apparatus, comprises a device 1 according to the present invention. The entertainment part 31 is shown to be controlled by the device 1. The device 3 may be a television set having tuner controlled by the selection device 1.

The present invention is based upon the insight that user satisfaction of recommendations is not only based on the accuracy of the recommendations but also on other factors, such as diversity and novelty. The present invention benefits from the further insight that properties of recommendation sets in addition to properties of individual recommendations can be used to improve recommendations.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. A device (1) for producing a selection from an items list (IL), the device comprising:
a storage unit (21) for storing the items list (IL),
an input/output unit (22) for interacting with a user (25), and
a selection unit (20) for selecting items from the items list and supplying the selected items to the input/output unit (22),
wherein the storage unit (21) is coupled with the input/output unit (22) for receiving first feedback (FB1) from the user and adjusting the items list in response to the first feedback, said first feedback relating to individual properties of the selected items, and
wherein the selection unit (20) is also coupled with the input/output unit (22) for receiving second feedback (FB2) from the user and adjusting the selection unit (20) in response to the second feedback, said second feedback relating to collective properties of the selected items.

2. The device according to claim 1, wherein the feedback comprises implicit feedback.

3. The device according to claim 1, wherein the feedback comprises explicit feedback.

4. The device according to claim 1, wherein the selection is a playlist.

5. The device according to claim 1, wherein the selection is presented to multiple users and wherein the feedback is received from multiple users.

6. The device according to claim 1, wherein the collective properties include at least one of:
accuracy,
novelty,
coverage,
serendipity,
diversity, and
overlap.

7. The device according to claim 1, wherein the recommendations concern audio and/or video clips, films, books, routes, CDs, DVDs, TV programs, musicals and/or plays.

8. An entertainment system or consumer device (3), comprising a device (1) according to claim 1.

9. The entertainment system or consumer device (3) according to claim 8, further comprising a server arranged for uploading recommended content.

10. A computer-implemented method for producing a selection from an items list (IL), the method comprising the steps of:
storing the items list (IL),
interacting with a user (25), and
selecting items from the items list and supplying the selected items to the input/output unit (22),
further comprising the steps of:
receiving first feedback (FB1) from the user and adjusting the items list in response to the first feedback, said first feedback relating to individual properties of the selected items, and
receiving second feedback (FB2) from the user and adjusting the selection unit (20) in response to the second feedback, said second feedback relating to collective properties of the selected items.

11. The method according to claim 10, wherein the feedback comprises implicit feedback.

12. The method according to claim 10, wherein the feedback comprises explicit feedback.

13. The method according to claim 10, wherein the set is a playlist.

14. The method according to claim 10, wherein the recommendations are made to multiple users and wherein the feedback is received from multiple users.

15. The method according to claim 10, wherein the collective properties include at least one of:
accuracy,
novelty,
coverage,
serendipity,
diversity, and
overlap.

16. The method according to claim 10, wherein the recommendations concern audio and/or video clips, films, books, routes, CDs, DVDs, TV programs, musicals and/or plays.

17. A computer program product for carrying out the method according to claim 10.
